(19) United States
(12) Patent Application Publication
(10) Pub. No.: US 2006/0172125 A1
(43) Pub. Date: Aug. 3, 2006

(54) Color-out corrections

(76) Inventors: Giulianna Romero-Nunez, Naples, FL (US); Myriam Nunez, Naples, FL (US); Manuel Romero, Naples, FL (US)

Correspondence Address: Giulianna Romero-Nunez, 116 Flame Vine Dr., Naples, FL, 34110, US

(21) Appl. No.: 11/046,528

(22) Filed: Jan. 31, 2005

(51) Int. Cl. B44C 1/17

(52) U.S. Cl. 428/195.1

(57) ABSTRACT

A liquid material container combination. The liquid material is used as a smooth cover-up of mistakes made on paper. The liquid material is of a color which is different from the color white. The colored liquid material is obtained by mixing the white material of a known “Liquid Paper” product with washable water colors, which mixture will obtain a smooth cover-up over any mistakes made on a paper-having the same color as the color of the liquid material. The container should display the particular color that is contained in the container.

### BACKGROUND OF THE INVENTION

The invention is directed to a liquid correction product that will be used to correct mistakes made on any surface of colored paper. Of course, The correction liquid has to be of the same color as the surface color of paper in order to be substantially invisible. A complete search has been made to find the white-out in a color but to no avail. In this day and age many presentations are made on colored paper and if any mistakes are made whether in typing or handwriting or any other mode of printing, they cannot be corrected by wiping out the mistakes by way of the so called “Liquid Paper”™ because the color white would not be invisible on any color surface paper. The known “White-outs” are sold in small plastic containers and the cap of the container has a small brush attached thereoto to be used to apply the liquid to the surface of paper to render the mistakes to be wiped-out or made invisible.

Another known product is the “Liquid Paper” correction pen wherein the correction fluid is contained in a pen configuration. The pen may be squeezed to control the correction fluid flowing from a fine needle tip onto the paper having the mistake thereon. The result is a neat and precise correction and the fluid will dry quickly with maximum coverage. However, the correction pen can only be used on white paper because the liquid is in a white color. No other colors are known to exist.

Still another mistake correctional system is known as the “Dryline” correction film. A thin white film is applied over the mistake, it dries quickly an can be written on immediately without leaving a “shadow” on subsequent photocopies. Again this film comes only in a white version. No colors are available.

### BRIEF DESCRIPTION OF THE INVENTION

Because of all of the above the inventive concept is directed to a plastic container having a colored liquid therein to cover or wipe out mistakes made on a colored surface paper. Of course, it is clear that many containers should be available for different color surface papers.

### DETAILED DESCRIPTION OF THE INVENTION

As part of the experimentation many different types of paint compositions have been tried to be mixed into existing brands of “White-outs. Such paint compositions are known as food colors, washable water paint, acrylics, fabric paints or markers, spray paints, oil paints, nail or hair dyes and the 3D paints. Such experimentation was undertaken to see which textures would mix easier and more thoroughly to obtain a smooth and quickly drying coverage on a paper surface. Also various known liquid “White-Outs” obtainable on the market were tested as to compatibility with the above noted different paints.

It turned out the product known as the “Sanford Paper Mate Smooth Coverage Liquid Paper” and the “Bic White Out” were most compatible with washable water colors because they blended very easily and left a smooth appearance when applied to the surface of paper. Any other paint and product combinations were found to dry too quickly and didn't allow enough time to mix the colors properly. Some of the combinations didn't mix well or not at all. Some of the combinations would leave streaks or dots on the paper. Others left a residue and the coverage was not smooth when it dried.

A diverse variety of colors were successfully obtained ranging from neon-pastel-primary bright such as blue, red, green, orange, yellow, pink, purple, brown and black.

In order to be successful, a multiple of containers must be used and displayed for sale with each container displaying the appropriate color contained therein on the label on the outside of the container or the cap of the container could be molded with the appropriate color exhibited therein. It is also possible to display the color of the liquid contained in the container by using a circular stick-on patch on top of the cap.

What we claim is:

1. A liquid material container combination wherein said liquid material is to be applied to a surface of a paper to cover mistakes appearing on said paper, said liquid material, when applied to said surface of said paper, dries quickly and smoothly and renders said mistakes invisible and can be written on within a short period of time, said liquid material is in a color which is different from the color white, said liquid material is in said container having a cap thereon including a small brush depending therefrom, said brush is used to apply said colored liquid material to a surface of a paper having the same color as said colored material contained in said container.

2. The liquid material of claim 1 is a mixture of the white material of a known “Liquid Paper” with washable water color materials.

3. The liquid material of claim 2 wherein many different washable water colors are being used to obtain different colors for differently colored papers.

4. The liquid material of claim 3 including a color display on said container, displaying the color contained in said container.
